(19) United States
(12) Patent Application Publication
(10) Pub. No.: US 2020/0293250 A1
(43) Pub. Date: Sep. 17, 2020

(54) IMAGE FORMING APPARATUS, INFORMATION PROCESSING APPARATUS, AND NON-TRANSITORY COMPUTER READABLE MEDIUM FOR PRINT JOB TIME MANANGEMENT

(71) Applicant: FUJI XEROX CO., LTD., Tokyo (JP)

(72) Inventor: Satoshi TAKAHASHI, Kanagawa (JP)

(73) Assignee: FUJI XEROX CO., LTD., Tokyo (JP)

(21) Appl. No.: 16/543,623

(22) Filed: Aug. 19, 2019

(30) Foreign Application Priority Data
Mar. 11, 2019 (JP) 2019-044215

(51) Int. Cl. G06F 3/12

(52) U.S. Cl. CPC G06F 3/1255; G06F 3/1292; G06F 3/1274

(57) ABSTRACT

An image forming apparatus includes a management section and an instruction section. The management section manages, in a case of accepting a print job, first information for identifying matter of content included in the print job in association with the print job. The instruction section gives, in a case where second information accepted from an information processing apparatus matches the first information, an instruction for executing the print job associated with the first information.

### CROSS-REFERENCE TO RELATED APPLICATIONS

This application is based on and claims priority under 35 USC 119 from Japanese Patent Application No. 2019-044215 filed Mar. 11, 2019.

### BACKGROUND

### (i) Technical Field

The present disclosure relates to an image forming apparatus, an information processing apparatus, and a non-transitory computer readable medium.

### (ii) Related Art

Currently, a service that allows a document print instruction to be given to a printer in, for example, an office from outside the office is commercially available. This service is sometimes called a cloud print service. The use of the cloud print service avoids the necessity of an operation of redisplaying a document created outside the office after the user's return to the office and giving a print instruction.

On the other hand, printing performed during the user's absence may cause inconveniences to the user. For example, the user needs to take time to search a pile of printed matter for printed matter output by the user, the user may pick wrong printed matter, highly confidential printed matter may be seen by another user, or printed matter may be lost. A printer shared by a plurality of users may also cause these inconveniences.

To minimize these inconveniences, a printer is provided with a function called security printing. With this function, a print job of a document is accumulated in the printer, performing of printing is suspended, and at the time point when authentication using an identification (ID) card, a password, or the like is successfully completed, printing is started (see Japanese Unexamined Patent Application Publication No. 2012-037986).

### SUMMARY

However, a mechanism for adding information concerning authentication to a print job is not present in commercially available cloud print services. Accordingly, a user of a cloud print service is unable to use security printing. The same applies to the Common Unix Printing System (CUPS), which is a print system based on Linux (registered trademark).

Aspects of non-limiting embodiments of the present disclosure relate to enabling management of the timing at which a print job is to be executed and a person executing the print job even in a case of using a print service in which a mechanism for adding information concerning authentication to the print job is not present.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming apparatus including a management section and an instruction section. The management section manages, in a case of accepting a print job, first information for identifying matter of content included in the print job in association with the print job. The instruction section gives, in a case where second information accepted from an information processing apparatus matches the first information, an instruction for executing the print job associated with the first information.

### BRIEF DESCRIPTION OF THE DRAWINGS

Exemplary embodiments of the present disclosure will be described in detail based on the following figures, wherein:

FIG. 1 is a diagram illustrating a conceptual configuration of an information processing system used in a first exemplary embodiment;

FIG. 2 is a diagram illustrating an example configuration of an image forming apparatus used in the first exemplary embodiment;

FIG. 3 is a diagram illustrating a functional configuration of a control unit used in the first exemplary embodiment;

FIG. 4 is a diagram illustrating an example configuration of a terminal apparatus used in the first exemplary embodiment;

FIG. 5 is a diagram illustrating a functional configuration of a control unit used in the first exemplary embodiment;

FIG. 6 is a diagram illustrating an example series of processes up to saving of a print job transmitted via a cloud print service on the image forming apparatus in a processing sequence in the first exemplary embodiment;

FIG. 7 is a diagram illustrating an example screen used to select a data file;

FIG. 8 is a diagram illustrating an example screen used to input setting information;

FIG. 9 is a diagram illustrating an example series of processes up to execution of a suspended print job in the processing sequence in the first exemplary embodiment;

FIG. 10 is a diagram illustrating an example screen used to display a list of file names;

FIG. 11 is a diagram illustrating example display of an error message;

FIG. 12 is a diagram illustrating an example series of processes up to saving of a print job transmitted via a cloud print service on the image forming apparatus in a processing sequence in a second exemplary embodiment;

FIG. 13 is a diagram illustrating a conceptual configuration of an information processing system used in a third exemplary embodiment;

FIG. 14 is a diagram illustrating a functional configuration of a control unit used in the third exemplary embodiment;

FIG. 15 is a diagram illustrating an example series of processes up to saving of a print job transmitted via a cloud print service on the image forming apparatus in a processing sequence in the third exemplary embodiment; and

FIG. 16 is a diagram illustrating an example series of processes up to execution of a suspended print job in the processing sequence in the third exemplary embodiment.

### DETAILED DESCRIPTION

Hereinafter, exemplary embodiments of the present disclosure will be described with reference to the drawings.

### First Exemplary Embodiment

### Overall Configuration of System

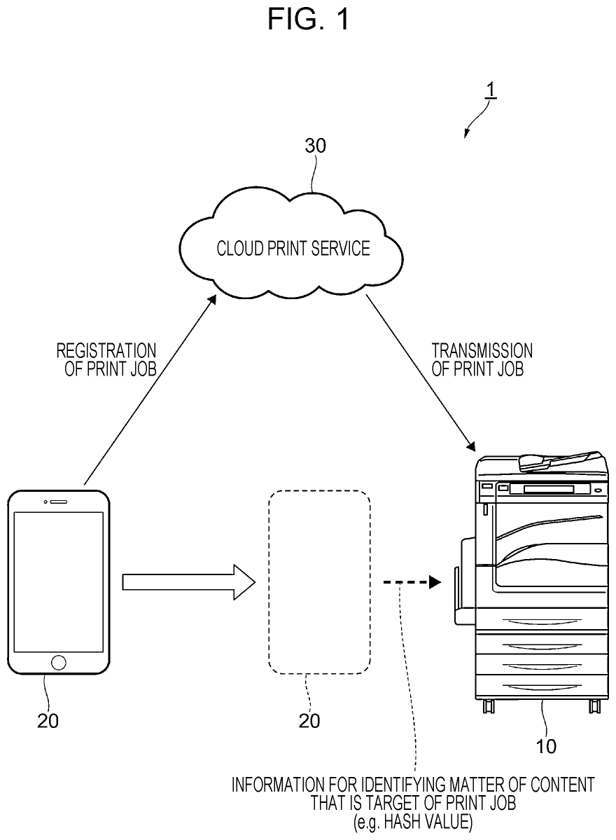

FIG. 1 is a diagram illustrating a conceptual configuration of an information processing system 1 used in a first exemplary embodiment. The information processing system 1 is constituted by an image forming apparatus 10 that has a function of suspending execution of a print job until a predetermined authentication operation is performed, a terminal apparatus 20 that is a portable apparatus operated by a user, and a cloud print service 30 that transmits a print job registered from the terminal apparatus 20 to the image forming apparatus 10 that is a specified destination.

FIG. 1 illustrates one image forming apparatus 10 and one terminal apparatus 20; however, a plurality of image forming apparatuses 10 and a plurality of terminal apparatuses 20 may be present in the information processing system 1. The terminal apparatus 20 is an example of the information processing apparatus.

The image forming apparatus 10 in this exemplary embodiment not only has basic functions that are used to form an image on a sheet or other recording media but also has a communication function that enables access to the Internet via a local area network (LAN), a communication function that enables access to a telephone network, and a near-field communication (NFC) communication function.

In this exemplary embodiment, the LAN may be a wired network or a wireless network or may be a network in which a wired network and a wireless network are mixed. The telephone network is used in facsimile communication.

The NFC communication function is one type of short-range wireless communication function. Communication between devices conforming to the NFC communication starts when the antennas (coils) of the respective devices approach each other within a range of, for example, 10 cm or less. As this type of communication standard, for example, ISO/IEC 14443 is available.

The body of the image forming apparatus 10 has a specific portion in which an antenna for NFC communication is disposed, and a mark (not illustrated) indicating a place to which the user is to bring the terminal apparatus 20 close is printed on the specific portion. In this exemplary embodiment, bringing the terminal apparatus 20 close to the mark is referred to as holding the terminal apparatus 20 over the image forming apparatus 10 or tapping the image forming apparatus 10 with the terminal apparatus 20.

The terminal apparatus 20 in this exemplary embodiment is a terminal that transmits a print job to the image forming apparatus 10 via the cloud print service 30. The terminal apparatus 20 in this exemplary embodiment is provided with the NFC function described above. As the terminal apparatus 20, for example, a smartphone, a laptop computer, a wristband-type wearable terminal, or an eyeglass-type head-mounted wearable terminal is assumed.

The cloud print service 30 provides a service of transmitting a print job registered in a cloud storage (not illustrated) to the image forming apparatus 10 that is specified at the time of registration.

The print job is formed of a data file containing content specified as a print target and values (setting information) for specifying operation conditions, etc. of the image forming apparatus 10 that is to print the content.

The content includes image data and document data. In a case of using the cloud print service 30, on a screen that is displayed on the terminal apparatus 20 and used to input setting information, an item for inputting information concerning authentication, such as personal identification information, is not present. Therefore, in an image forming apparatus other than the image forming apparatus 10 used in this exemplary embodiment, printing is started at the time point when a print job is received from the cloud print service 30.

On the other hand, in this exemplary embodiment, when the user moves to a place where the image forming apparatus 10 is installed and holds the terminal apparatus 20 over the image forming apparatus 10 as illustrated in FIG. 1, information for identifying matter of content that is the target of the print job is fed to the image forming apparatus 10 from the terminal apparatus 20.

The image forming apparatus 10 compares the information received from the terminal apparatus 20 with information generated therein for identifying the matter of the content of the print job and allows execution of the print job that is accumulated on condition that the pieces of information match. That is, the information for identifying the matter of the content is directly fed to the image forming apparatus 10 from the terminal apparatus 20 at the place where the image forming apparatus 10 is installed, thereby implementing a service equivalent to security printing.

### Configurations of Apparatuses

### Configuration of Image Forming Apparatus

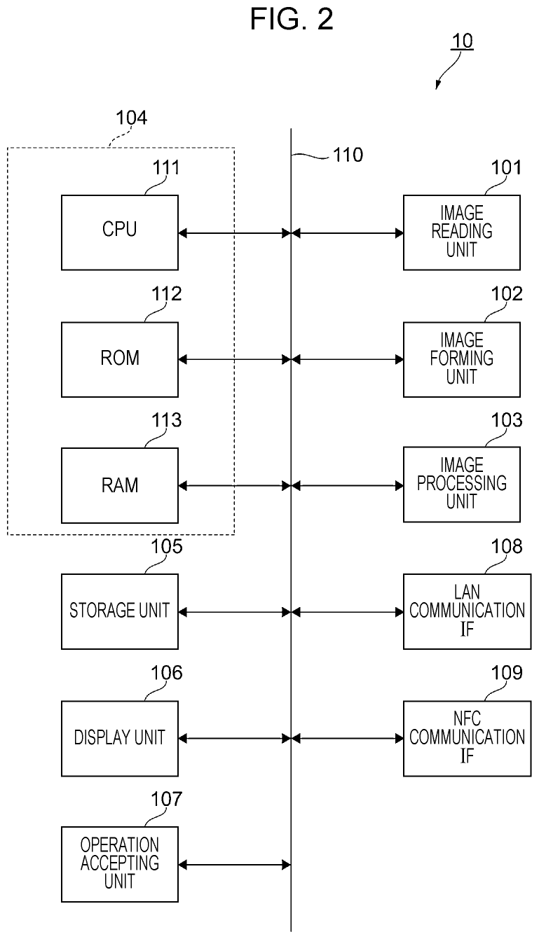

FIG. 2 is a diagram illustrating an example configuration of the image forming apparatus 10 used in the first exemplary embodiment.

The image forming apparatus 10 includes an image reading unit 101 that reads an image of a document, an image forming unit 102 that forms an image on a sheet, which is an example of a recording medium, an image processing unit 103 that performs processes including color correction, tone correction, etc. on image data, a control unit 104 that controls operations of the image forming apparatus 10 as a whole, a storage unit 105 that stores image data and so on, a display unit 106 that is used to display a user interface screen and so on, an operation accepting unit 107 that accepts user operations, a LAN communication interface (LAN communication IF) 108 that implements communication via a telephone line, a LAN cable, or the like, and an NFC communication interface (NFC communication IF) 109 that implements NFC communication.

The image reading unit 101 is a general scanner and may have a mechanism for automatically conveying documents.

The image forming unit 102 is a unit that forms an image on a recording medium and has a mechanism that corresponds to the forming method.

The image processing unit 103 is formed of a dedicated processor, processing circuit, and so on for processing image data.

The control unit 104 includes a central processing unit (CPU) 111, a read-only memory (ROM) 112 that stores firmware, a basic input output system (BIOS), and so on, and a random access memory (RAM) 113 that is used as a work area. The control unit 104 functions as a general computer.

The storage unit 105 is formed of, for example, a hard disk drive (HDD) or a semiconductor memory, which is a nonvolatile storage device. In the storage unit 105, image data read by the image reading unit 101, image data received externally through communication, a facsimile data received through facsimile communication, and so on are saved. Some of the pieces of image data received externally through communication are print jobs received via the cloud print service 30. As described above, content data that is the target of a print job is not limited to image data and includes document data. The storage unit 105 is also used to save management information described below.

The display unit 106 is formed of, for example, a liquid crystal display or an organic electroluminescence (EL) display.

The operation accepting unit 107 is formed of a touch sensor, a switch, a button, and so on disposed on the surface of the display unit 106.

The control unit 104 and the other units and so on are connected to each other via a bus 110 or a signal line not illustrated.

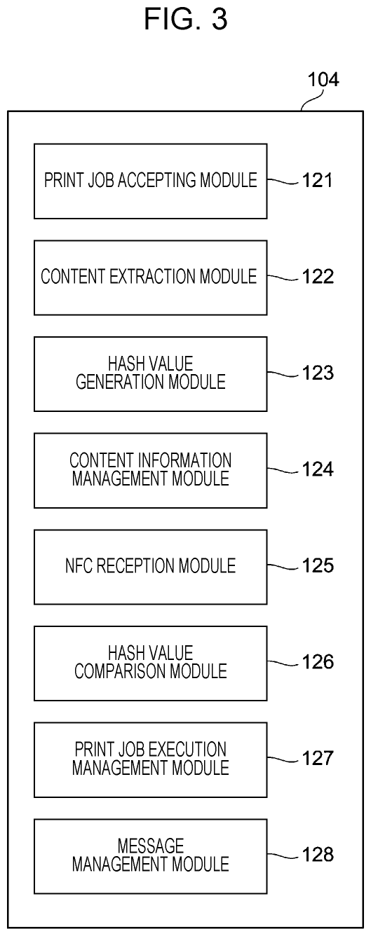

FIG. 3 is a diagram illustrating a functional configuration of the control unit 104 used in the first exemplary embodiment. The functional modules illustrated in FIG. 3 are implemented by the CPU 111 (see FIG. 2) executing a program. The functional modules illustrated in FIG. 3 are examples of functional modules provided by the control unit 104.

The control unit 104 in this exemplary embodiment has functions of the following units: a print job accepting module 121 that performs a process for accepting a print job; a content extraction module 122 that extracts content data from a print job; a hash value generation module 123 that generate a hash value of extracted content data; a content information management module 124 that manages a management number (which is an ID) of a print job and a corresponding hash value in association with each other; an NFC reception module 125 that implements NFC communication; a hash value comparison module 126 that compares a hash value received through NFC communication with a hash value stored on the image forming apparatus 10; a print job execution management module 127 that manages execution of a print job; and a message management module 128 that manages output of a message for a user.

The print job accepting module 121 in this exemplary embodiment manages a received print job with a management number. The management number is issued, for example, each time a print job is accepted. The print job accepting module 121 stores the received print job and the management number in the storage unit 105 (see FIG. 2).

The print job accepting module 121 in this exemplary embodiment does not distinguish channels through which respective print jobs are received. That is, the print job accepting module 121 does not determine whether a print job is received via the cloud print service 30 (see FIG. 1) or via a LAN or the like not illustrated. Therefore, the same process is uniformly applied to received print jobs.

The content extraction module 122 extracts a data file containing content from the print job. As described above, a print job is formed of a data file containing content and setting information. The extracted data file is fed to the hash value generation module 123.

The hash value generation module 123 feeds the extracted data file to a known calculation algorithm to generate a hash value. In this exemplary embodiment, the hash value generation module 123 calculates a hash value from the entire data file; however, the hash value generation module 123 may generate a hash value from part of the data file in accordance with an agreement shared with the terminal apparatus 20 (see FIG. 1). This agreement is information for specifying part, of the data file, that is used to generate a hash value. In the agreement, for example, the first page of document data is specified. The hash value described here is an example of first information for identifying matter of content included in a print job.

The content information management module 124 stores the generated hash value and the management number of the corresponding print job in the storage unit 105 (see FIG. 2) in association with each other. The content information management module 124 described here is an example of a management section.

The NFC reception module 125 receives a hash value from the terminal apparatus 20 (see FIG. 1) that is brought close to the image forming apparatus 10 over the specific portion of the image forming apparatus 10. The terminal apparatus 20 is able to perform NFC communication, and the user is positioned near the image forming apparatus 10. The hash value received from the terminal apparatus 20 is an example of second information for identifying matter of content included in a print job.

The hash value comparison module 126 compares the hash value received from the terminal apparatus 20 with all hash values generated in the image forming apparatus 10 and stored in the storage unit 105. In other words, the hash value comparison module 126 searches for a hash value that matches the hash value received from the terminal apparatus 20 among the hash values generated in the image forming apparatus 10. The hash value comparison module 126 outputs the presence or absence of a hash value that matches the hash value received from the terminal apparatus 20 as the comparison result.

The print job execution management module 127 reads a print job on the basis of a management number associated with the matching hash value in a case where the comparison result indicates “presence”, and gives an instruction for executing the read print job. In other words, the print job execution management module 127 resets the suspend state of the corresponding print job and supplies the print job to the image processing unit 103 (see FIG. 2). The print job execution management module 127 described here is an example of an instruction section.

The message management module 128 displays, on the display unit 106 (see FIG. 2), a message indicating that a print job for which the user wants to perform printing is not present in the image forming apparatus 10 in a case where the comparison result indicates “absence”. The message management module 128 is an example of an output section.

### Configuration of Terminal Apparatus

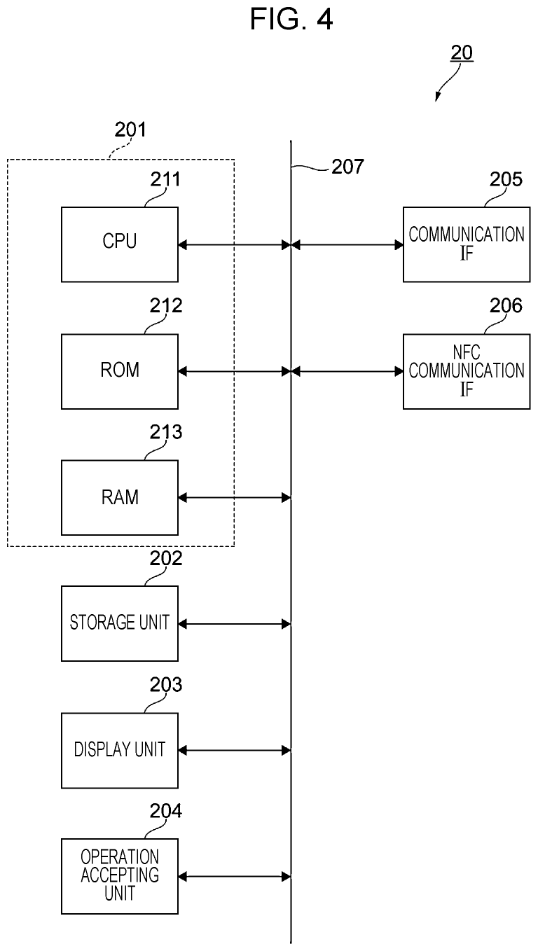

FIG. 4 is a diagram illustrating an example configuration of the terminal apparatus 20 used in the first exemplary embodiment.

The terminal apparatus 20 includes a control unit 201 that controls operations of the terminal apparatus 20 as a whole, a storage unit 202 that stores image data and so on, a display unit 203 that is used to display a user interface screen and so on, an operation accepting unit 204 that accepts user operations, a communication interface (communication IF) 205 that implements communication via a LAN cable, Wi-Fi (registered trademark), or the like, and an NFC communication interface (NFC communication IF) 206 that implements NFC communication.

The control unit 201 in this exemplary embodiment includes a CPU 211, a ROM 212 that stores firmware, a BIOS, and so on, and a RAM 213 that is used as a work area. The control unit 201 functions as a general computer.

The storage unit 202 is formed of, for example, an HDD, which is a nonvolatile storage device, or a nonvolatile rewritable semiconductor memory. The storage unit 202 may differ depending on the product form of the terminal apparatus 20. In the storage unit 202, for example, file data of content that is a print target is saved. In the storage unit 202, a hash value of content data that is output as a print job is also saved.

The display unit 203 is formed of, for example, a liquid crystal display or an organic EL display. On the display unit 203, for example, an operation screen that is used to select content that is set as a print target is displayed.

The operation accepting unit 204 is formed of a touch sensor, a switch, a button, and so on disposed on the surface of the display unit 203.

The control unit 201 and the other units and so on are connected to each other via a bus 207 or a signal line not illustrated.

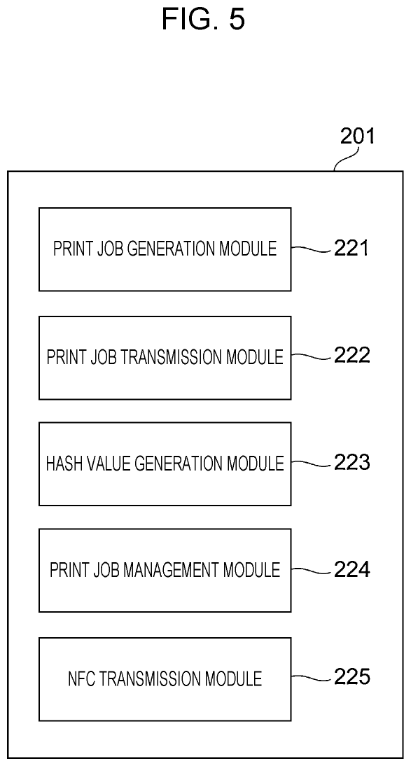

FIG. 5 is a diagram illustrating a functional configuration of the control unit 201 used in the first exemplary embodiment. The functional modules illustrated in FIG. 5 are implemented by the CPU 211 (see FIG. 4) executing a program. The functional modules illustrated in FIG. 5 are examples of functional modules provided by the control unit 201.

The control unit 201 in this exemplary embodiment has functions of the following units: a print job generation module 221 that generates a print job of content specified by the user; a print job transmission module 222 that transmits a print job to the cloud print service 30 (see FIG. 1); a hash value generation module 223 that generates a hash value of content data corresponding to a transmitted print job; a print job management module 224 that manages a print job that is not yet output; and an NFC transmission module 225 that implements NFC communication.

The print job generation module 221 generates a print job of content for which the user gives an instruction for printing on an operation screen. As described above, a print job is formed of a data file and setting information.

The print job transmission module 222 transmits the generated print job to a specified destination. The print job transmission module 222 in this exemplary embodiment transmits the print job to the cloud print service 30 (see FIG. 1), which is the destination. The final destination is the image forming apparatus 10 (see FIG. 1) selected on an operation screen. The print job transmission module 222 described here is an example of an upload section.

The hash value generation module 223 generates a hash value that is used as information for identifying matter of the content that is the target of the print job. The hash value described here is an example of the second information.

In this exemplary embodiment, the hash value generation module 223 uses a known calculation algorithm to calculate a hash value from the entire data file that forms the print job.

The calculation algorithm that is used by the hash value generation module 223 to calculate a hash value is specified in advance so that the calculation algorithm is the same as the calculation algorithm used by the image forming apparatus 10 (see FIG. 1). Specifically, the calculation algorithm is specified in an application program that is executed by the control unit 201.

As described above, a hash value may be generated from a specific part of the data file; however, information about the specific part that is used to generate the hash value needs to be shared with the image forming apparatus 10.

The print job management module 224 manages the name of the data file (hereinafter referred to as “file name”) corresponding to the print job transmitted to the cloud print service 30 (see FIG. 1) and the generated hash value in association with each other. The combination of the data file name and the hash value is saved in the storage unit 202 (see FIG. 4). The file name is displayed on an operation screen that is used by the user to instruct the image forming apparatus 10 to perform printing.

For example, there may be a case where the number of print jobs displayed on the operation screen is small and a case where a print job need not be selected from displayed print jobs (for example, a case where all print jobs displayed on the operation screen are selected). In these cases, no display of file names causes little inconvenience to the user.

Accordingly, as management information of a print job, the combination of the management number of the print job and the hash value may be saved instead of the combination of the file name and the hash value.

When NFC communication is made possible in a state where the management number of a print job or a file name is specified on the operation screen, the NFC transmission module 225 transmits a hash value corresponding to the specified print job or file name. The NFC transmission module 225 is an example of a transmission section.

### Example Processing Sequence

Now, a processing sequence that is executed in the information processing system 1 (see FIG. 1) in this exemplary embodiment are described.

The processing sequence in this exemplary embodiment is formed of two series of processes.

One is a series of processes up to saving of a print job on the image forming apparatus 10, the print job being transmitted via the cloud print service 30 by the user operating the terminal apparatus 20 connected to a network that is different from a network to which the image forming apparatus 10 is connected.

The other is a series of processes up to execution of a corresponding print job by the image forming apparatus 10 in which authentication of information received through NFC communication is successfully completed.

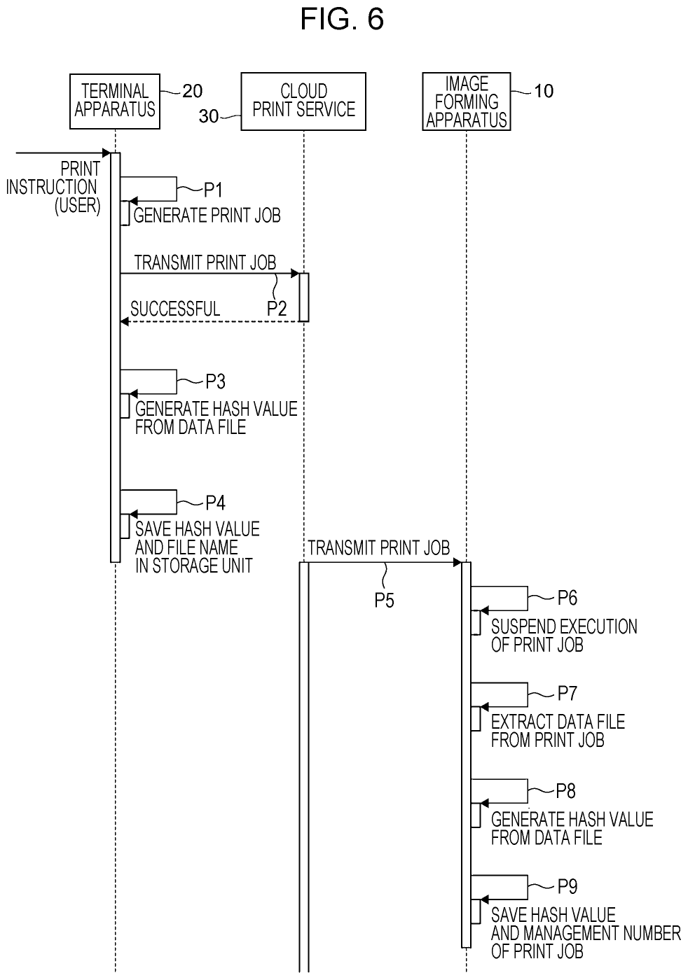

FIG. 6 is a diagram illustrating an example series of processes up to saving of a print job transmitted via the cloud print service 30 on the image forming apparatus 10 in the processing sequence in the first exemplary embodiment. The letter P in FIG. 6 represents “process”.

This series of processes is started in response to the user specifying a data file that is set as a print target and giving an instruction for performing cloud printing.

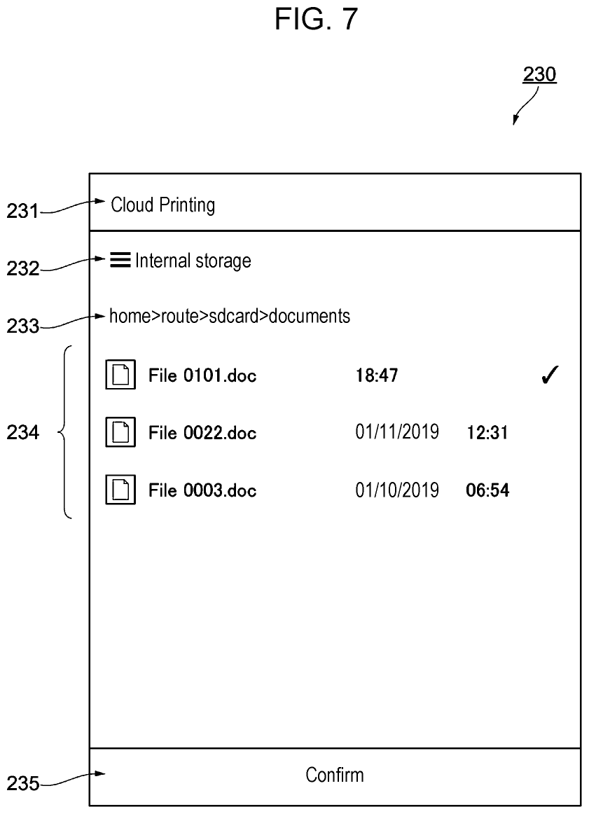

FIG. 7 is a diagram illustrating an example screen 230 used to select a data file.

The screen 230 includes a title field 231, a display field 232 in which a storage that is being browsed is displayed, a display field 233 in which the current directory is displayed, a display field 234 in which data files saved in the current directory are displayed, and a button 235 for confirming selection.

In the case illustrated in FIG. 7, the title field 231 reads “Cloud Printing”. The tile “Cloud Printing” indicates that the current operation screen is a screen for setting printing that uses the cloud print service 30.

In the case of the screen 230, in the display field 234, the names of three data files stored in the “document” folder in the internal storage are displayed. Among the three data files, a data file selected by the user is “File 0101.doc”.

When the user performs a tap operation on the button 235 on the screen 230, the data file that is set as a print target is confirmed.

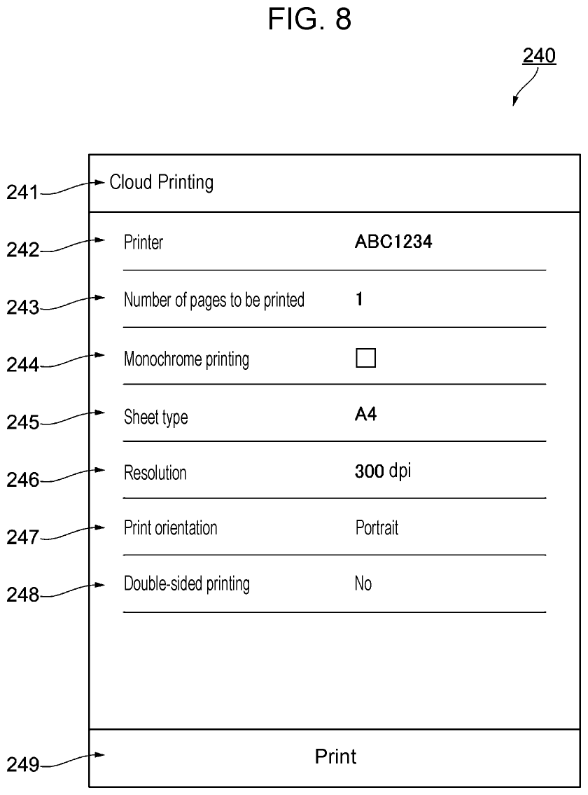

FIG. 8 is a diagram illustrating an example screen 240 used to input setting information.

The screen 240 includes a title field 241, setting information fields 242 to 248 in which setting information may be set, and a button 249 for giving an instruction for performing printing.

In the setting information field 242, information for identifying the image forming apparatus 10 that is used to print content is displayed. In the case illustrated in FIG. 8, the name of the image forming apparatus 10 specified by the user is “ABC1234”.

In the setting information field 243, the number of pages to be printed may be specified. In the case illustrated in FIG. 8, the number of pages is “1”. In this exemplary embodiment, the number of pages is the same as the number of copies.

In the setting information field 244, monochrome printing may be specified. In the case illustrated in FIG. 8, the checkbox is unchecked, and therefore, color printing is performed in a case where the data file contains a color document.

In the setting information field 245, the sheet type may be specified. In the case illustrated in FIG. 8, “A4” is specified.

In the setting information field 246, the resolution may be specified. The resolution also affects the print quality. As the resolution increases, the print quality increases. In the case illustrated in FIG. 8, the resolution is 300 dots per inch.

In the setting information field 247, the print orientation may be specified. In the case illustrated in FIG. 8, the print orientation is “portrait”.

In the setting information field 248, the double-sided printing may be specified. In the case illustrated in FIG. 8, the double-sided printing is set to “No”. That is, single-side printing is specified.

When the user performs a tap operation on the button 249, the values set in the setting information fields 243 to 248 for the pieces of setting information that form a print job are confirmed.

Setting information that may be specified further includes, for example, the following information: information in which whether to enable a function of putting together and printing a plurality of pages in one page is specified; information in which the number of pages that are put together is specified in a case of enabling the function; information in which the method of paper ejection is specified; information in which whether to perform sorting is specified; and information in which whether to allow post-processing is specified.

Referring back to FIG. 6, a description is given.

When accepting an instruction for cloud printing from the user, the terminal apparatus 20 generates a print job for which the output destination is a specific image forming apparatus 10 (process 1). The print job is formed of a data file and setting information.

After generating the print job, the terminal apparatus 20 transmits the print job to the cloud print service 30 (process 2). When successfully receiving the print job, the cloud print service 30 returns a response indicating “successful” to the terminal apparatus 20.

When acknowledging the response indicating “successful”, the terminal apparatus 20 generates a hash value from the data file that forms the print job (process 3). In this exemplary embodiment, the entire data file is a target.

Thereafter, the terminal apparatus 20 saves the generated hash value and the file name in the storage unit 202 (see FIG. 4) (process 4).

On the other hand, when receiving the print job, the cloud print service 30 transmits the print job to the image forming apparatus 10 that is specified as the output destination (process 5). In this exemplary embodiment, the cloud print service 30 only functions as a transfer section. Therefore, the cloud print service 30 does not add any changes to the print job.

The image forming apparatus 10 starts processing in response to reception of the print job.

When receiving the print job, the image forming apparatus 10 issues a management number for the print job and saves the received print job in the storage unit 105 (see FIG. 2). The image forming apparatus 10 suspends execution of the saved print job (process 6). Execution is suspended here regardless of whether the print job is received via the cloud print service 30. That is, execution of any print job is suspended.

Next, the image forming apparatus 10 extracts the data file from the print job (process 7) and generates a hash value from the extracted data file (process 8).

Thereafter, the image forming apparatus 10 saves the hash value and the management number of the print job in the storage unit 105 (process 9).

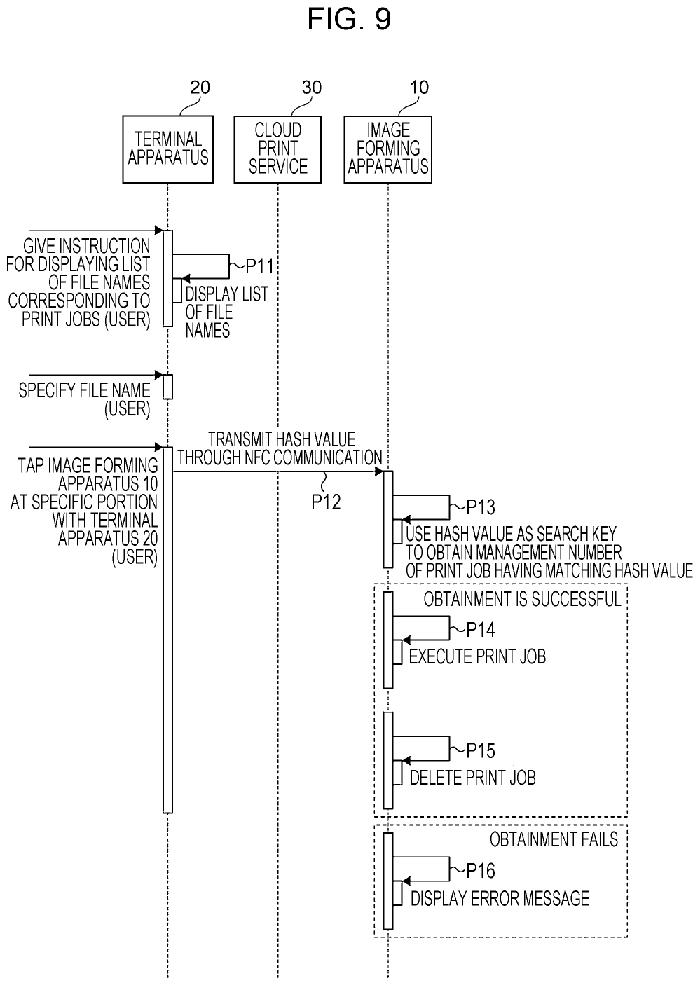

FIG. 9 is a diagram illustrating an example series of processes up to execution of a suspended print job in the processing sequence in the first exemplary embodiment. The letter P in FIG. 9 represents “process”.

This series of processes is started in response to the user instructing the terminal apparatus 20 to display a list of file names corresponding to print jobs.

When receiving the instruction, the terminal apparatus 20 displays a list of file names on an operation screen (process 11).

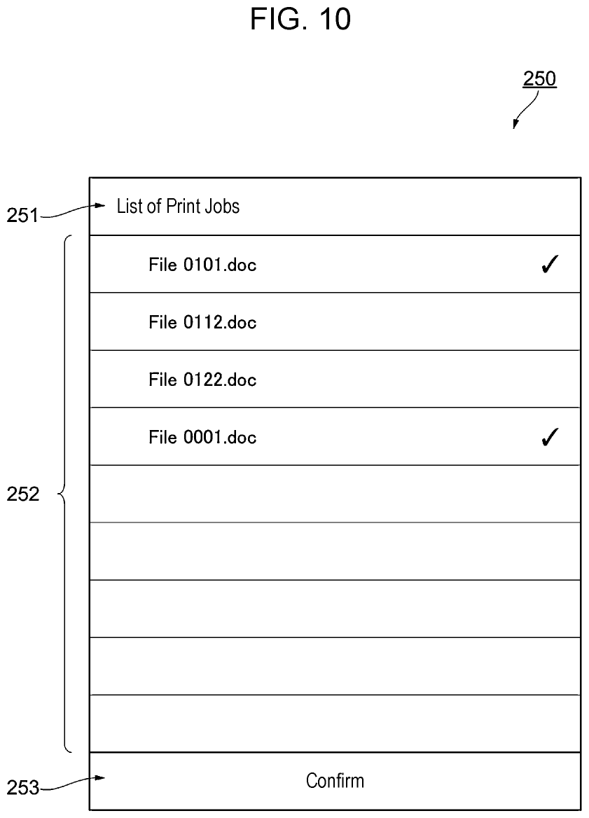

FIG. 10 is a diagram illustrating an example screen 250 used to display a list of file names.

The screen 250 includes a title field 251, a display field 252 in which the names of files saved as print jobs are displayed, and a button 253 for confirming selection.

In the case illustrated in FIG. 10, the title field 251 reads “List of Print Jobs”. In the display field 252 for file names, file names corresponding to print jobs for which cloud printing is specified are displayed. In the case illustrated in FIG. 10, four file names are displayed, and two file names among the four file names are selected by the user. As a matter of course, any number of file names may be selected.

When the user performs a tap operation on the button 253 on the screen 250, the data files for which printing is to be performed are confirmed.

Referring back to FIG. 9, a description is further given.

When accepting specification of a file name, the terminal apparatus 20 reads a hash value corresponding to the accepted file name so as to be ready for NFC communication. The terminal apparatus 20 may add a flag to only the hash value that is a target of NFC communication instead of writing the hash value to a memory area for NFC communication.

When the user confirms selection of the file name, and thereafter, taps the image forming apparatus 10 at the specific portion with the terminal apparatus 20, the terminal apparatus 20 for which NFC communication is made possible transmits the hash value that has been read for transmission through NFC communication (process 12).

The NFC communication is established with only the image forming apparatus 10 that is tapped.

When receiving the hash value through the tap with the terminal apparatus 20, the image forming apparatus 10 uses the received hash value as a search key and obtains the management number of a print job having a hash value that matches the received hash value (process 13).

In a case where a matching hash value is found (in a case where obtainment is successful), the image forming apparatus 10 executes the print job by using the management number associated with the hash value (process 14). Because the hash values match, the image forming apparatus 10 verifies that a data file corresponding to the print job that is suspended is present in the terminal apparatus 20. After execution of the print job, the image forming apparatus 10 deletes the print job from the storage unit 105 (see FIG. 2) of the image forming apparatus 10 (process 15).

On the other hand, in a case where a matching hash value is not found (in a case where obtainment fails), the image forming apparatus 10 displays an error message on the display unit 106 (see FIG. 2) (process 16).

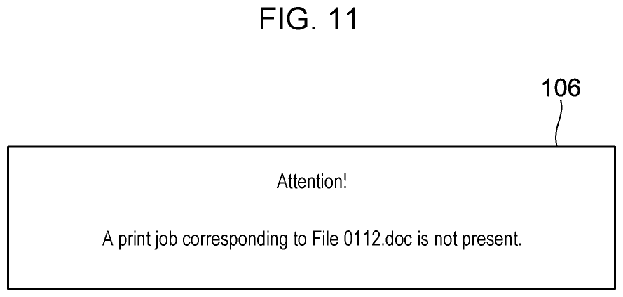

FIG. 11 is a diagram illustrating example display of the error message. The error message is displayed on the display unit 106 of the image forming apparatus 10. In this example, a message stating “Attention!/A print job corresponding to File 0112.doc is not present” is displayed. Here, “/” represents a line break on the screen.

In a case where the file names are the same but the pieces of matter of the respective data files differ, the hash values do not match. In this case, the image forming apparatus 10 determines that the user of the terminal apparatus 20 with which the image forming apparatus 10 is tapped has no right to execute the print job, and an error message is displayed for the user.

As described above, when the information processing system 1 in this exemplary embodiment is used, even in a case of using the cloud print service 30 that is unable to transmit a print job with personal identification information, a print job is executed only for a user having a data file corresponding to the print job. In other words, also in cloud printing, management of the timing at which a print job is to be executed and a person executing the print job is made possible as in security printing in which a print job with authentication information is transmitted.

For a Portable Document Format (PDF) file or a Joint Photographic Experts Group (JPEG) file, an ID and a password may be embedded in a specific data area. However, when, for example, a PDF file is printed in a text format or in a HyperText Markup Language (HTML) format, the embedded ID and password are disclosed. Further, it is not desirable to transmit a password over the Internet from a security perspective.

On the other hand, in the information processing system 1 in this exemplary embodiment, authentication information is not transmitted over the Internet, which is desirable from a security perspective.

### Second Exemplary Embodiment

Now, the information processing system 1 having a security level higher than that in the first exemplary embodiment is described.

In this exemplary embodiment, the value of at least one of the pieces of setting information that form a print job and a data file are used to calculate a hash value. That is in this exemplary embodiment, additional information is also used so as to generate a different hash value even for the same data file.

At least one of the pieces of setting information is an example of predetermined information. A hash value is generated by using the value of a specific predetermined piece of setting information among the pieces of setting information. For example, a value set for the number of pages to be printed is used. Further, for example, a value indicating monochrome printing or color printing or a value indicating a sheet type may be used.

In a case where a piece of setting information that is used to generate a hash value is, for example, the number of pages to be printed, a numerical value (for example, “1”), specified by the user is used as a salt in hash calculation. In a case where a piece of setting information that is used to generate a hash value is a setting indicating monochrome printing or color printing, a value specified by the user (for example, a value indicating color printing) is used as a salt in hash calculation.

A piece of setting information, among the pieces of setting information defining print conditions, to be used in calculation of a hash value is agreed upon in advance between the image forming apparatus 10 and the terminal apparatus 20. Specifically, the piece of setting information is agreed upon between an application program running on the image forming apparatus 10 and an application program running on the terminal apparatus 20.

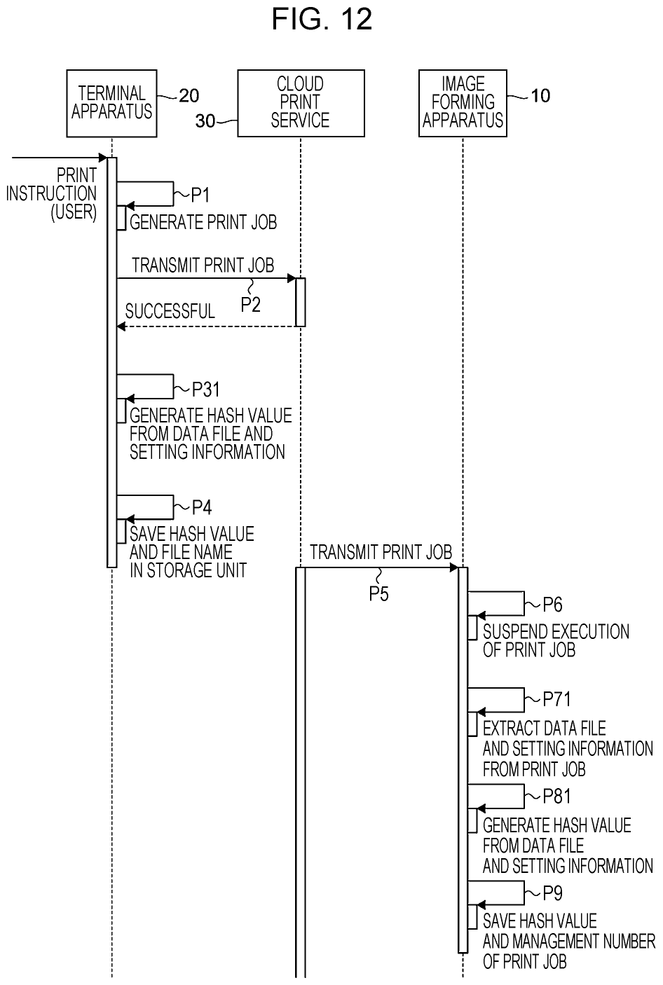

FIG. 12 is a diagram illustrating an example series of processes up to saving of a print job transmitted via the cloud print service 30 on the image forming apparatus 10 in a processing sequence in a second exemplary embodiment. In FIG. 12, a process the same as that in FIG. 6 is assigned the same reference numeral.

This series of processes differs in three respects: process 31 is performed instead of process 3; process 71 is performed instead of process 7; and process 81 is performed instead of process 8.

Process 31 is performed in the terminal apparatus 20, and process 71 and process 81 are performed in the image forming apparatus 10.

In process 31, a hash value is generated from the data file and setting information. In process 71, the data file and setting information are extracted from the print job. In process 81, a hash value is generated from the extracted data file and setting information.

The number of pieces of setting information that are used to generate a hash value is not limited to one and may be two or more.

One piece of setting information used to generate a hash value refers to one specific predetermined piece of setting information among the plurality of pieces of setting information that define print conditions for the image forming apparatus 10. Two or more pieces of setting information used to generate a hash value refer to two or more specific pieces of setting information among the plurality of pieces of setting information that define print conditions for the image forming apparatus 10.

### Third Exemplary Embodiment

### Overall Configuration of System

The above-described exemplary embodiments assume the case where one user has a data file containing content that is used in generating a print job. In this exemplary embodiment, a case is described where a user who generates a print job and a user who executes the print job are different.

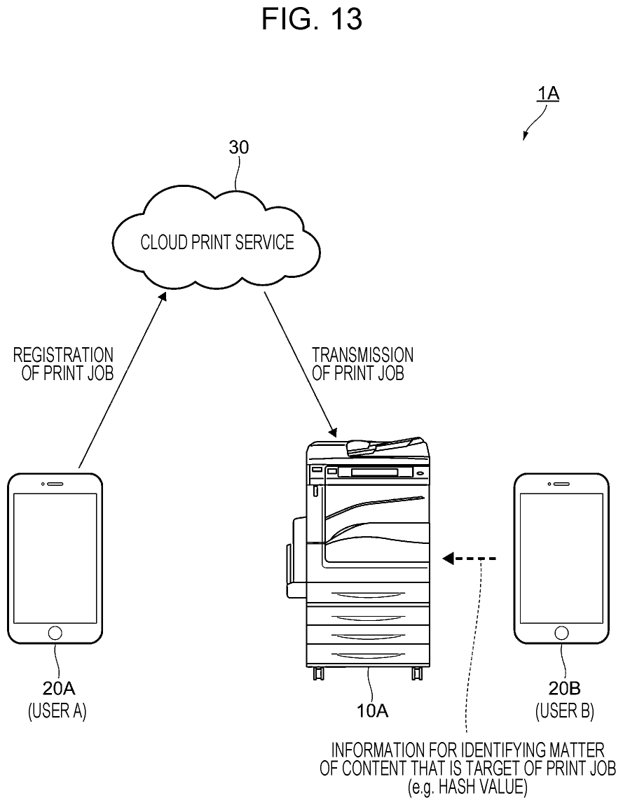

FIG. 13 is a diagram illustrating a conceptual configuration of an information processing system 1A used in a third exemplary embodiment. The information processing system 1A is constituted by an image forming apparatus 10A, a terminal apparatus 20A that is a portable apparatus operated by a user A, a terminal apparatus 20B that is a portable apparatus operated by a user B, and the cloud print service 30 that transmits a print job from the terminal apparatus 20A registered in a cloud storage not illustrated to the image forming apparatus 10A.

In this exemplary embodiment, the user A is a user issuing a print job, and the user B is a user executing the print job. The user A in this exemplary embodiment needs to have an environment in which the cloud print service 30 is available as in the above-described exemplary embodiments. On the other hand, the user B need not have an environment in which the cloud print service 30 is available; however, the user B may have an environment in which the cloud print service 30 is available.

In this exemplary embodiment, the user A and the user B share a data file that is set as the target of the print job. For example, the data file may be shared via a cloud storage or the data file may be shared by attaching the data file to, for example, an email and transmitting the data file to the user B from the user A. Any method for sharing the data file may be used.

### Configurations of Apparatuses

The apparatus configurations of the terminal apparatuses 20A and 20B are the same as that in the first exemplary embodiment. The apparatus configuration of the image forming apparatus 10A is described below. The hardware configuration of the image forming apparatus 10A is the same as that in the first exemplary embodiment. The image forming apparatus 10A is different from the first exemplary embodiment in the functional configuration.

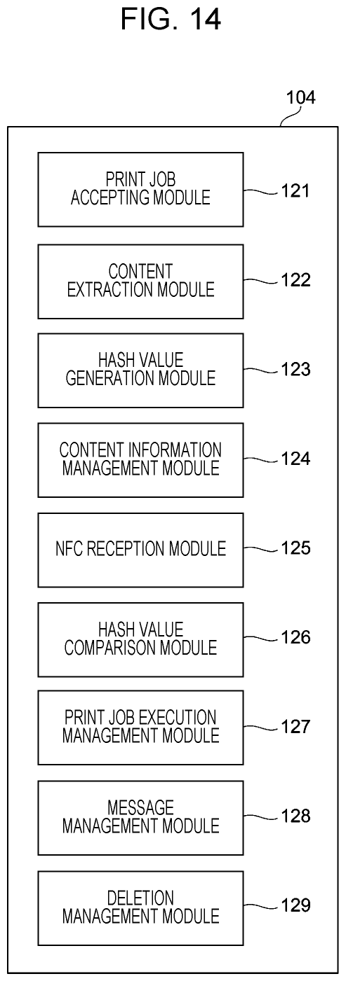

FIG. 14 is a diagram illustrating a functional configuration of the control unit 104 used in the third exemplary embodiment. In FIG. 14, a constituent element the same as that in FIG. 3 is assigned the same reference numeral.

In the functional configuration illustrated in FIG. 14, a constituent element specific to this exemplary embodiment is a deletion management module 129 that manages deletion of a print job.

The deletion management module 129 manages deletion of a print job on the basis of a time elapsed since registration of the print job regardless of whether the print job is executed or the number of times the print job is executed. Therefore, even if the user B does not yet execute the print job, the print job is deleted when a predetermined time elapses. On the other hand, even if the user B has executed the print job, the print job is not deleted but retained until the predetermined time elapses. Accordingly, within the predetermined time, the user B is allowed to execute the print job a plurality of times. In a case where, in addition to the user B, a user C is present who shares the data file, the plurality of users are allowed to execute one print job a plurality of times.

### Example Processing Sequence

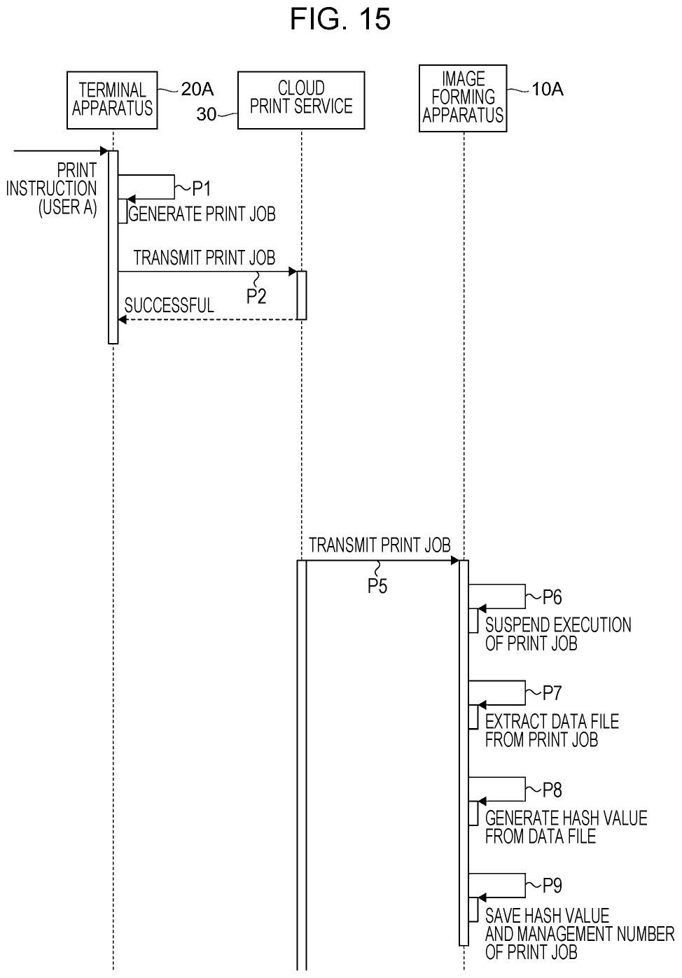

FIG. 15 is a diagram illustrating an example series of processes up to saving of a print job transmitted via the cloud print service 30 on the image forming apparatus 10A in a processing sequence in the third exemplary embodiment. In FIG. 15, a process the same as that in FIG. 6 is assigned the same reference numeral.

The processing sequence illustrated in FIG. 15 is different from the processing sequence illustrated in FIG. 6 in that, in the terminal apparatus 20A operated by the user A who has issued a print job, a hash value is not generated after transmission of the print job to the cloud print service 30. A hash value is not generated, and therefore, saving of the hash value and the file name in the storage unit 202 (see FIG. 4) in association with each other is not performed.

When receiving the print job, the image forming apparatus 10A performs operations similar to those in the first exemplary embodiment.

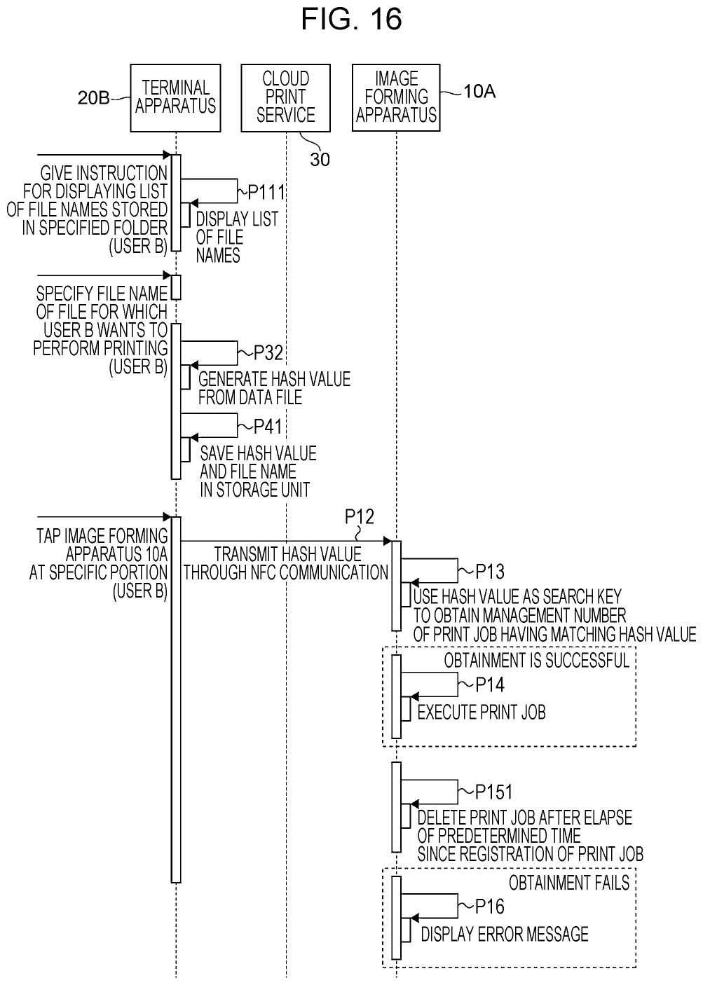

FIG. 16 is a diagram illustrating an example series of processes up to execution of a suspended print job in the processing sequence in the third exemplary embodiment. In FIG. 16, a process the same as that in FIG. 9 is assigned the same reference numeral.

In the case illustrated in FIG. 16, the series of processes is started in response to the user B operating the terminal apparatus 20B to instruct the terminal apparatus 20B to display a list of file names stored in a specified folder. When receiving the instruction, the terminal apparatus 20B displays a list of file names stored in the folder specified by the user B (process 111).

Next, the user B specifies, on the terminal apparatus 20B, the file name of a file for which the user B wants to perform printing. However, a hash value corresponding to the file name specified by the user B is not stored on the terminal apparatus 20B from which the print job is not issued.

Accordingly, the terminal apparatus 20B generates a hash value from a data file corresponding to the specified file name at this time point (process 32). Next, the terminal apparatus 20B saves the generated hash value and the file name in the storage unit 202 (see FIG. 4) (process 41).

Thereafter, when the user B taps the image forming apparatus 10 at the specific portion with the terminal apparatus 20B, the terminal apparatus 20B for which NFC communication is made possible transmits the hash value that has been read for transmission through NFC communication (process 12).

When receiving the hash value through the tap with the terminal apparatus 20B, in a case where a print job having a hash value that matches the received hash value is found, the image forming apparatus 10A executes the print job, and in a case where such a print job is not found, the image forming apparatus 10A displays an error message, as in the first exemplary embodiment (processes 13, 14, and 16).

The image forming apparatus 10A in this exemplary embodiment deletes the print job after the elapse of a predetermined time since registration of the print job (process 151). In other words, even if the image forming apparatus 10A has executed the print job, the image forming apparatus 10A does not delete but retains the print job until the predetermined time elapses.

The deletion management module 129 (see FIG. 14) described above monitors the time elapsed since the registration date and time for every print job retained on the image forming apparatus 10A.

In this exemplary embodiment, the user A who issues a print job may give an instruction for executing the print job. Therefore, in a case where the user A wants to execute the print job, the same processing as that in the terminal apparatus 20B operated by the user B is performed. That is, after the user A has specified the file name of a file for which the user A wants to perform printing, a hash value of a corresponding data file is generated and transmitted to the image forming apparatus 10A through NFC communication.

### Other Exemplary Embodiments

Although the exemplary embodiments of the present disclosure have been described above, the technical scope of the present disclosure is not limited to the scope described in the above exemplary embodiments. It is obvious from the description of the claims that various modifications and alterations made to the above-described exemplary embodiments fall within the technical scope of the present disclosure.

In the above-described exemplary embodiments, the case where a print job is transmitted to the image forming apparatus 10 or the like via the cloud print service 30 has been described. The above-described exemplary embodiments are applicable to a print system that does not handle security printing. For example, the above-described exemplary embodiments may be applied to, for example, the Common UNIX Printing System (CUPS), which is a Linux print system.

In the above-described exemplary embodiments, as a mechanism for transmitting a hash value to the image forming apparatus 10 or the like, NFC communication is used; however, a wireless communication method, such as Bluetooth (registered trademark), Wi-Fi (registered trademark), or ZigBee (trademark), may be used.

In the above-described exemplary embodiments, a hash value is used as example information for identifying matter of content included in a print job; however, any information may be used instead of a hash value as long as the information is generated from content included in a print job. For example, in a case where content is formed of a plurality of pages, a specific page may be used. For example, the first page or the last page may be transmitted from the terminal apparatus 20 to the image forming apparatus 10. The specific page is not limited to one page. The specific page is an example of part of the content. Part of the content need not be specified on a per page basis, and may be a specific area or the like within a page or may be attribute information.

In the above-described exemplary embodiments, the error message is displayed on the image forming apparatus 10; however, the error message may be displayed on the terminal apparatus 20 or the like in a case where transmission of the error message is possible. The error message may be transmitted through NFC communication or may be transmitted via the cloud print service 30. The error message may be transmitted by using a wireless communication method, such as Bluetooth.

In the first exemplary embodiment described above, the terminal apparatus 20 generates a hash value at the time point when the terminal apparatus 20 receives a response indicating “successful” for transmission of a print job to the cloud print service 30. However, a hash value may be generated and saved during a period until the terminal apparatus 20 is used to tap the image forming apparatus 10. For example, a hash value may be generated and saved after selection of a file name corresponding to the print job.

In the second exemplary embodiment described above, the case has been described where, as example predetermined information to be used in calculating a hash value in addition to a data file, at least one of the pieces of setting information defining print conditions is used. However, a fixed value determined in advance between the image forming apparatus 10 and the terminal apparatus 20 may be used. The fixed value may be, for example, a secret key.

In the third exemplary embodiment described above, the case has been described where a print job is deleted after the elapse of a predetermined time since registration of the print job; however, the print job may be deleted after the print job has been executed as in the first and second exemplary embodiments. The print job may be deleted when the number of times the print job is executed reaches a predetermined number.

In the first exemplary embodiment, the terminal apparatus 20 does not manage execution of a print job, and therefore, a print job that has been executed by the image forming apparatus 10 may be displayed in a list of print jobs. Accordingly, the file name of a file for which transmission of a hash value through NFC communication is successfully completed may be deleted from the list of print jobs.

However, if the corresponding file name is deleted from the list of print jobs at the time point when transmission through NFC communication is successfully completed, in a case where the user accidentally taps the image forming apparatus 10 that is different from the transmission destination of the print job, the user needs to redo issuance of the print job from scratch. Therefore, the file name may be deleted from the list of print jobs on condition that feedback indicating that a print job including a hash value that matches the transmitted hash value is found in the image forming apparatus 10 is received.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

1. An image forming apparatus comprising a processor, configured to:
manage, in a case of accepting a print job, first information for identifying matter of content included in the print job in association with the print job; and
give, in a case where second information accepted from an information processing apparatus matches the first information, an instruction for executing the print job associated with the first information, wherein the first information and the second information are a hash value independently generated on the basis of the content or part of the content.

2. The image forming apparatus according to claim 1, wherein the first information and the second information are calculated on the basis of the content.

3. (canceled)

4. The image forming apparatus according to claim 2, wherein the first information and the second information are calculated on the basis of the content and predetermined information.

5. The image forming apparatus according to claim 4, wherein the predetermined information is at least one piece of information that is included in the print job and that defines a print condition.

6. The image forming apparatus according to claim 4, wherein the predetermined information is a fixed value agreed upon in advance with the information processing apparatus.

7. The image forming apparatus according to claim 1, the processor is further configured to output, in a case where the first information that matches the second information is not present, a message indicating absence of a print job specified via the information processing apparatus.

8. The image forming apparatus according to claim 7, wherein the processor is further configured to transmit the message to the information processing apparatus.

9. The image forming apparatus according to claim 1, wherein even in a case where execution of the print job has been confirmed, the print job is not deleted.

10. The image forming apparatus according to claim 9, wherein the print job is deleted after an elapse of a predetermined time since a time point when the print job is accepted.

11. A non-transitory computer readable medium storing a program causing a computer to execute a process for image forming, the process comprising:
managing, in a case of accepting a print job, first information for identifying matter of content included in the print job in association with the print job; and
giving, in a case where second information accepted from an information processing apparatus matches the first information, an instruction for executing the print job associated with the first information, wherein the first information and the second information are a hash value independently generated on the basis of the content or part of the content.

12. The non-transitory computer readable medium according to claim 11, wherein the first information and the second information are calculated on the basis of the content.

13. The non-transitory computer readable medium according to claim 11, wherein the process further comprises outputting, in a case where the first information that matches the second information is not present, a message indicating absence of a print job specified via the information processing apparatus.

14. The non-transitory computer readable medium according to claim 11, wherein even in a case where execution of the print job has been confirmed, the print job is not deleted.

15. An information processing apparatus comprising processor, configured to:
upload a print job of selected content to a storage area in a network; and
transmit, in a case where communication with an image forming apparatus is made possible in a state where one print job is selected from among print jobs accumulated in an internal storage, information for identifying matter of content that is a target of the selected print job to the image forming apparatus, wherein the information for identifying matter of content that is a target of the selected print job to the image forming apparatus is a hash value independently generated on the basis of the content or part of the content.

16. The information processing apparatus according to claim 15, wherein the information for identifying the matter of the content is calculated on the basis of the content.
